(19) United States
(12) Patent Application Publication
(10) Pub. No.: US 2024/0297371 A1
(43) Pub. Date: Sep. 5, 2024

(54) BATTERY INSULATION SHIELD

(71) Applicant: Ford Global Technologies, LLC, Dearborn, MI (US)

(72) Inventor: Xiaogang Zhang, Novi, MI (US)

(21) Appl. No.: 18/115,922

(22) Filed: Mar. 1, 2023

(51) Int. Cl. H01M 10/658; H01M 50/209

(52) U.S. Cl. CPC H01M 10/658; H01M 50/209

(57) ABSTRACT

An insulation shield for a battery pack includes a shield body that is configured to be positioned between adjacent battery components, and a wrapping structure comprising a plurality of bands. At least one band of the plurality of bands extends around the shield body in a longitudinal direction and at least one other band of the plurality of bands extends around the shield body in a lateral direction.

### TECHNICAL FIELD

This disclosure relates generally to providing one or more battery insulation shields in a traction battery pack.

### BACKGROUND

Electrified vehicles include a traction battery pack for powering electric machines and other electrical loads of the vehicle. The traction battery pack includes one or more battery arrays that each include a plurality of battery cells and various other battery internal components that support electric vehicle propulsion.

### SUMMARY

In some aspects, the techniques described herein relate to an insulation shield for a battery pack, including: a shield body that is configured to be positioned between adjacent battery components; and a wrapping structure comprising a plurality of bands, wherein at least one band of the plurality of bands extends around the shield body in a longitudinal direction, and wherein at least one other band of the plurality of bands extends around the shield body in a lateral direction.

In some aspects, the techniques described herein relate to an insulation shield for a battery pack, wherein the at least one band of the plurality of bands comprises a plurality of first bands that extend around the shield body in the longitudinal direction; and/or wherein the at least one other band of the plurality of bands comprises a plurality of second bands that extend around the shield body in the lateral direction.

In some aspects, the techniques described herein relate to an insulation shield for a battery pack, wherein the plurality of first bands are spaced apart from each other in the lateral direction; and/or wherein the plurality of second bands are spaced apart from each other in the longitudinal direction.

In some aspects, the techniques described herein relate to an insulation shield for a battery pack including both the plurality of first bands and the plurality of second bands.

In some aspects, the techniques described herein relate to an insulation shield for a battery pack, wherein the plurality of first bands comprises at least three first bands and wherein the plurality of second bands comprises at least three second bands.

In some aspects, the techniques described herein relate to an insulation shield for a battery pack, wherein each of the first and second bands comprises a wire strip.

In some aspects, the techniques described herein relate to an insulation shield for a battery pack, wherein the wire strip has a width that is at least twice a thickness of the wire strip.

In some aspects, the techniques described herein relate to an insulation shield for a battery pack, wherein the shield body is comprised of a plurality of layers.

In some aspects, the techniques described herein relate to an insulation shield for a battery pack, wherein the plurality of layers comprise at least a first aerogel layer and a second aerogel layer with a first metal layer between the first and second aerogel layers, and further including a second metal layer on a side of the first aerogel layer that is opposite of the first metal layer, and a third metal layer on a side of the second aerogel layer that is opposite of the first metal layer.

In some aspects, the techniques described herein relate to an insulation shield for a battery pack, wherein the shield body comprises a first side, a second side opposite the first side, a first pair of opposing end faces, and a second pair of opposing end faces, and wherein each first band comprises a discrete closed loop that surrounds the shield body and contacts the first and second sides as well as the first pair of opposing end faces, and wherein each second band comprises a discrete closed loop that surrounds the shield body and contacts the first and second sides as well as the second pair of opposing end faces.

In some aspects, the techniques described herein relate to an insulation shield for a battery pack, wherein the first bands and second bands overlap each other in discrete locations.

In some aspects, the techniques described herein relate to a battery pack, including: at least one battery array including a plurality of battery cells; and an insulation shield that is positioned between at least two battery cells of the plurality of battery cells, wherein the insulation shield is comprised of a plurality of layers, and including a first plurality of bands that extend around the insulation shield in a longitudinal direction and a second plurality of bands that extend around the insulation shield in a lateral direction to form a wrapped structure.

In some aspects, the techniques described herein relate to a battery pack, wherein the at least one battery array comprises a plurality of battery arrays, and including at least one additional insulation shield positioned between adjacent battery arrays of the plurality of battery arrays.

In some aspects, the techniques described herein relate to a battery pack, wherein each of the first and second bands comprises a wire strip.

In some aspects, the techniques described herein relate to a battery pack, wherein the plurality of layers comprise at least a first aerogel layer and a second aerogel layer with a first metal layer between the first and second aerogel layers, and further including a second metal layer on a side of the first aerogel layer that is opposite of the first metal layer, and a third metal layer on a side of the second aerogel layer that is opposite of the first metal layer.

In some aspects, the techniques described herein relate to a battery pack, wherein the insulation shield comprises a first side, a second side opposite the first side, a first pair of opposing end faces, and a second pair of opposing end faces, and wherein each first band comprises a discrete closed loop that surrounds the insulation shield and contacts the first and second sides as well as the first pair of opposing end faces, and wherein each second band comprises a discrete closed loop that surrounds the insulation shield and contacts the first and second sides as well as the second pair of opposing end faces.

In some aspects, the techniques described herein relate to a battery pack, wherein the first bands and second bands overlap each other in discrete locations.

In some aspects, the techniques described herein relate to a method including: providing an insulation shield comprised of a plurality of layers; wrapping at least one first band around the insulation shield in a longitudinal direction; and wrapping at least one second band around the insulation shield in a lateral direction to form a wrapped structure to be placed between adjacent battery components.

In some aspects, the techniques described herein relate to a method, wherein the at least one first band comprises a plurality of first bands and including wrapping the plurality of first bands around the insulation shield in the longitudinal direction, wherein the plurality of first bands are spaced apart from each other in the lateral direction, and wherein the at least one second band comprises a plurality of second bands and including wrapping the plurality of second bands around the insulation shield in the lateral direction, wherein the plurality of second bands are spaced apart from each other in the longitudinal direction.

In some aspects, the techniques described herein relate to a method including using a wire strip to form each of the first and second bands.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates a perspective view of an array of the battery pack from the electrified vehicle of FIG. 2 according to an exemplary embodiment of the present disclosure.

FIG. 3 illustrates a schematic side view of an insulation shield positioned between two battery arrays according to an exemplary embodiment of the present disclosure.

FIG. 4 illustrates a schematic side view of an insulation shield positioned between two battery cells of the battery array according to an exemplary embodiment of the present disclosure.

FIG. 5 illustrates a perspective view of the insulation shield of FIGS. 3 and 4.

FIG. 6A illustrates a perspective view of a wrapping structure for the insulation shield of FIG. 5.

FIG. 6B illustrates a schematic top view of a metal strip used in the wrapping structure of FIG. 6A.

FIG. 6C illustrates a schematic side view of the metal strip of FIG. 6B.

FIG. 7 illustrates a perspective view of the wrapping structure of FIG. 6A installed on the insulation shield of FIG. 5 according to an exemplary embodiment of the present disclosure.

FIG. 8 is a graph of temperature v. time comparison between an insulation shield with the wrapping structure of FIG. 6A and an insulation shield wrapped with a sheet of material.

### DETAILED DESCRIPTION

This disclosure details a traction battery pack assembly having battery arrays that include a plurality of battery cells. Insulation shields with a wrapping structure are positioned between battery cells in selected arrangements. The disclosure additionally details an exemplary method of providing a wrapped insulation shield.

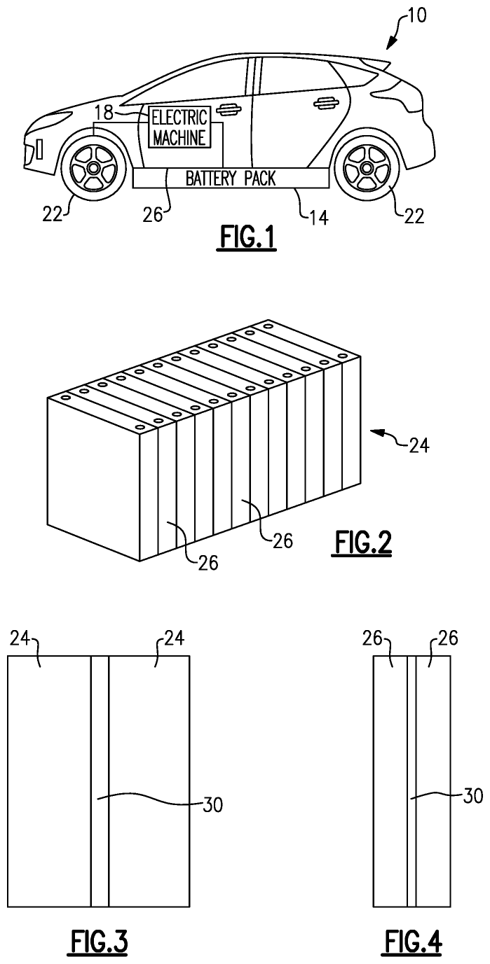

With reference to FIG. 1, an electrified vehicle 10 includes a traction battery pack assembly 14, an electric machine 18, and wheels 22. The traction battery pack assembly 14 powers an electric machine 18, which can convert electrical power to mechanical power to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference now to FIGS. 2-3 the traction battery pack assembly 14 includes one or more battery arrays 24 that are configured to be housed within an enclosure (not shown). The battery arrays 24 each include a plurality of individual battery cells 26 as shown in FIG. 2. In this example, the battery arrays 24 include twelve battery cells 26. However, other numbers of battery cells 26 could be used in arrays 24 in other examples. Additionally, any number of battery arrays 24 could be used in the vehicle.

In an embodiment, the battery cells 26 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

From time to time, pressure and thermal energy within one or more of the battery cells 26 can increase. The pressure and thermal energy increase can be due to an overcharge condition, an overdischarging condition, or short circuit events, for example. The pressure and thermal energy increase can cause the associated battery cell 26 to rupture and release gas from within an interior of the associated battery cell 26. The gases may be caused by an applied force or a thermal event, and can either cause or exacerbate an existing battery thermal event. A relatively significant amount of heat can be generated during battery thermal events.

In one example, to prevent battery thermal propagation across the battery array 24, an insulation shield 30 is used between a certain number of battery cells 26 and/or between adjacent arrays 24 as shown in FIGS. 3-4. In the example shown in FIG. 3, the insulation shield 30 is positioned between two battery arrays 24. In the example shown in FIG. 4, the insulation shield 30 is positioned between at least two battery cells 26.

In one example, the insulation shield 30 is comprised of a plurality of layers as shown in FIG. 5. In one example, the plurality of layers comprise at least a first aerogel layer 32 and a second aerogel layer 34 with a first metal layer 36 between the first 32 and second 34 aerogel layers. Additionally, the plurality of layers may include a second metal layer 38 on a side of the first aerogel layer 32 that is opposite of the first metal layer 36 and a third metal layer 40 on a side of the second aerogel layer 34 that is opposite of the first metal layer 36. In one example, the metal layers 36, 38, 40 are comprised of aluminum; however, other types of material could also be used.

An aerogel is an open-celled, mesoporous, solid foam that is composed of a network of interconnected nanostructures and that exhibits a porosity (non-solid volume) of no less than 50%. The term “mesoporous” refers to a material that contains pores ranging from 2 to 50 nm in diameter. Most acrogels exhibit between 90 to 99.8+ % porosity and also contain a significant amount of microporosity, i.e. pores less than 2 nm in diameter. These low-density, highly-porous solid materials are light and durable and are very effective for insulation purposes. One example aerogel is a silica aerogel; however, any suitable aerogel could be used.

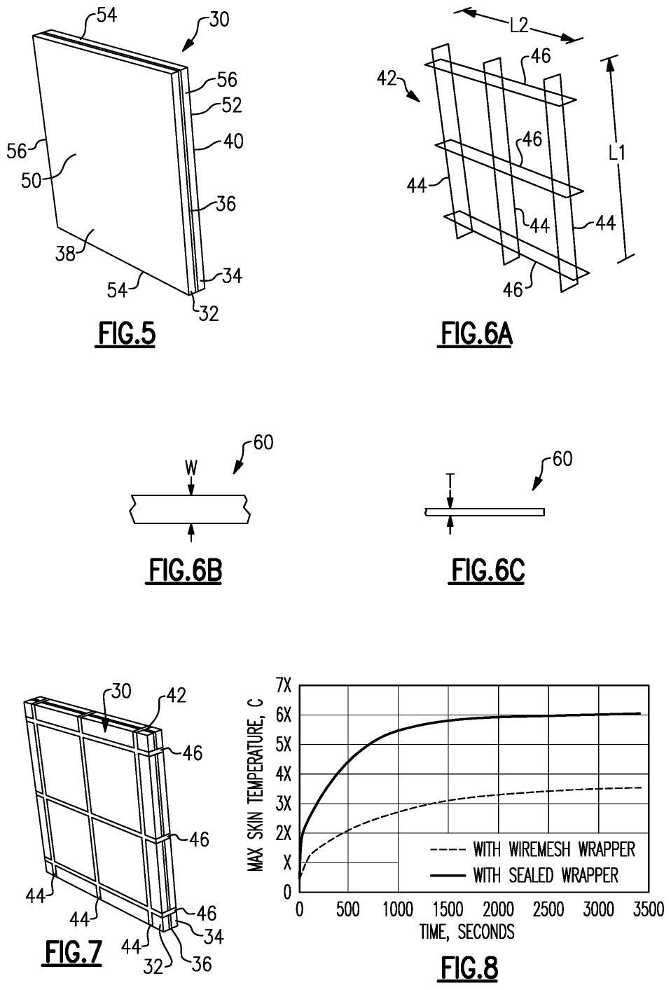

In one example, a wrapping structure 42 (FIG. 6A) is used to maintain the structural integrity of the layered insulation shield 30. In one example, the wrapping structure 42 comprises a plurality of bands. In one example, the plurality of bands includes at least a first plurality of bands 44 that extend around the insulation shield 30 in a longitudinal direction L1 and a second plurality of bands 46 that extend around the insulation shield 30 in a lateral direction L2 to form a wrapped structure as shown in FIG. 7.

In one example, the insulation shield 30 comprises a first side 50, a second side 52 opposite the first side, a first pair of opposing end faces 54, and a second pair of opposing end faces 56. In one example, each first band 44 comprises a discrete closed loop that surrounds the insulation shield 30 and contacts the first 50 and second 52 sides as well as the first pair of opposing end faces 54. Similarly, each second band 46 comprises a discrete closed loop that surrounds the insulation shield 30 and contacts the first 50 and second 52 sides as well as the second pair of opposing end faces 56. The plurality of first bands 44 are spaced apart from each other in the lateral direction and the plurality of second bands 46 are spaced apart from each other in the longitudinal direction. In one example, the first bands 44 and second bands 46 overlap each other in discrete locations. The bands 44, 46 are snugly fit around the insulation shield 30 to maintain the structural integrity of the shield 30.

In one example, each of the first 44 and second 46 bands comprises a wire strip 60 or bundle as shown in FIG. 6B-6C. In one example, each wire strip 60 has a rectangular cross-section shape. In one example, the wire strip 60 has a width W that is at least twice a thickness T of the wire strip. In one example, the thickness T of the wire strip is 0.05 mm and the width of the metal strip is 1 mm.

In the example shown in FIGS. 6-7, the wrapping structure 42 is comprised of three bundles/first bands 44 that are in the longitudinal direction and three bundles/second bands 46 that are in the lateral direction. One of the first bands 44 extends around a middle or central location of the insulation shield 30 and other two first bands 44 are close to left and right edges of the shield 30. Similarly, one of the second bands 46 extends around a middle or central location of the insulation shield 30 and other two second bands 46 are close to top and bottom edges of the shield 30.

FIG. 8 shows a performance comparison between a sealed wrapper and a wire-mesh wrapper comprised of the plurality of bands 44, 46. The sealed wrapper configuration comprises a thin metal sheet that completely surrounds and encloses an entirety of the insulation shield. However, due to a thermal short circuit over the four edges of the sealed wrapper, the performance of the insulation shield is degraded. Significant temperature reduction was found with the wire wrapper configuration, as the maximum skin temperature was reduced by at least 40%, while the thermal propagation time was increased from 180 s to 1400 s. Additionally, the wire wrapper configuration is more effective than a sealed wrapping configuration from a pricing perspective as there is significantly less material.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An insulation shield for a battery pack, comprising:
a shield body that is configured to be positioned between adjacent battery components; and
a wrapping structure comprising a plurality of bands, wherein at least one band of the plurality of bands extends around the shield body in a longitudinal direction, and wherein at least one other band of the plurality of bands extends around the shield body in a lateral direction.

2. The insulation shield according to claim 1, wherein the at least one band of the plurality of bands comprises a plurality of first bands that extend around the shield body in the longitudinal direction; and/or
wherein the at least one other band of the plurality of bands comprises a plurality of second bands that extend around the shield body in the lateral direction.

3. The insulation shield according to claim 2, wherein the plurality of first bands are spaced apart from each other in the lateral direction; and/or
wherein the plurality of second bands are spaced apart from each other in the longitudinal direction.

4. The insulation shield according to claim 3, including both the plurality of first bands and the plurality of second bands.

5. The insulation shield according to claim 4, wherein the plurality of first bands comprises at least three first bands and wherein the plurality of second bands comprises at least three second bands.

6. The insulation shield according to claim 2, wherein each of the first and second bands comprises a wire strip.

7. The insulation shield according to claim 6, wherein the wire strip has a width that is at least twice a thickness of the wire strip.

8. The insulation shield according to claim 2, wherein the shield body is comprised of a plurality of layers.

9. The insulation shield according to claim 8, wherein the plurality of layers comprise at least a first aerogel layer and a second aerogel layer with a first metal layer between the first and second aerogel layers, and further including a second metal layer on a side of the first aerogel layer that is opposite of the first metal layer, and a third metal layer on a side of the second aerogel layer that is opposite of the first metal layer.

10. The insulation shield according to claim 2, wherein the shield body comprises a first side, a second side opposite the first side, a first pair of opposing end faces, and a second pair of opposing end faces, and wherein each first band comprises a discrete closed loop that surrounds the shield body and contacts the first and second sides as well as the first pair of opposing end faces, and wherein each second band comprises a discrete closed loop that surrounds the shield body and contacts the first and second sides as well as the second pair of opposing end faces.

11. The insulation shield according to claim 10, wherein the first bands and second bands overlap each other in discrete locations.

12. A battery pack comprising:
at least one battery array including a plurality of battery cells; and
an insulation shield that is positioned between at least two battery cells of the plurality of battery cells, wherein the insulation shield is comprised of a plurality of layers, and including a first plurality of bands that extend around the insulation shield in a longitudinal direction and a second plurality of bands that extend around the insulation shield in a lateral direction to form a wrapped structure.

13. The battery pack according to claim 12, wherein the at least one battery array comprises a plurality of battery arrays, and including at least one additional insulation shield positioned between adjacent battery arrays of the plurality of battery arrays.

14. The battery pack according to claim 12, wherein each of the first and second bands comprises a wire strip.

15. The battery pack according to claim 12, wherein the plurality of layers comprise at least a first aerogel layer and a second aerogel layer with a first metal layer between the first and second aerogel layers, and further including a second metal layer on a side of the first aerogel layer that is opposite of the first metal layer, and a third metal layer on a side of the second aerogel layer that is opposite of the first metal layer.

16. The battery pack according to claim 12, wherein the insulation shield comprises a first side, a second side opposite the first side, a first pair of opposing end faces, and a second pair of opposing end faces, and wherein each first band comprises a discrete closed loop that surrounds the insulation shield and contacts the first and second sides as well as the first pair of opposing end faces, and wherein each second band comprises a discrete closed loop that surrounds the insulation shield and contacts the first and second sides as well as the second pair of opposing end faces.

17. The battery pack according to claim 16, wherein the first bands and second bands overlap each other in discrete locations.

18. A method comprising:
providing an insulation shield comprised of a plurality of layers;
wrapping at least one first band around the insulation shield in a longitudinal direction; and
wrapping at least one second band around the insulation shield in a lateral direction to form a wrapped structure to be placed between adjacent battery components.

19. The method according to claim 18, wherein the at least one first band comprises a plurality of first bands and including wrapping the plurality of first bands around the insulation shield in the longitudinal direction, wherein the plurality of first bands are spaced apart from each other in the lateral direction, and wherein the at least one second band comprises a plurality of second bands and including wrapping the plurality of second bands around the insulation shield in the lateral direction, wherein the plurality of second bands are spaced apart from each other in the longitudinal direction.

20. The method according to claim 18, including using a wire strip to form each of the first and second bands.
